(19) United States
(12) Patent Application Publication
(10) Pub. No.: US 2012/0170894 A1
(43) Pub. Date: Jul. 5, 2012

(54) OPTICAL FIBER CONNECTOR

(75) Inventor: CHIA-LING HSU, Tu-Cheng (TW)

(73) Assignee: HON HAI PRECISION INDUSTRY CO., LTD., Tu-Cheng (TW)

(21) Appl. No.: 13/091,143

(22) Filed: Apr. 21, 2011

(30) Foreign Application Priority Data
Dec. 29, 2010 (TW) 99146459

(51) Int. Cl. G02B 6/38

(52) U.S. Cl. 385/74

(57) ABSTRACT

An optical fiber connector includes a number of lensed optical fibers and a body. Each lensed optical fiber includes a core portion, a cladding layer, and an optical lens. The core portion includes a first end and a second end opposite to the first end. The cladding layer wraps around the first end. The optical lens is formed on a distal surface of the second end. The body defines a number of receiving through holes. The lensed optical fibers are inserted in the respective receiving through holes with the optical lenses disposed at openings of the receiving through holes.

### BACKGROUND

1. Technical Field

The present disclosure relates to optics and, particularly, to an optical fiber connector.

2. Description of Related Art

An optical fiber connector is preferred for use in data transmission between electronic devices due to its high transmission speed and signal integrity. An optical fiber connector includes a body having a number of blind holes, a number of lenses positioned on a light incident surface of the body, a number of optical fibers received in the respective blind holes and aligned with the respective lenses.

When in use, two optical fiber connectors are coupled with each other, as well the optical fibers are received in the respective optical fiber connectors and are coupled together to allow optical transmittance between the optical fibers. However, light emitted from each optical fiber reaches the corresponding lens after passing through a body portion between the blind hole and the lens. The light path is complex as the body portion is a refracting interface. This decreases transmission efficiency.

Therefore, it is desirable to provide an optical fiber connector, which can overcome or at least alleviate the limitations described.

### BRIEF DESCRIPTION OF THE DRAWINGS

FIG. 1 is a schematic, isometric view of an optical fiber connector including two lensed optical fibers, according to a first exemplary embodiment.

FIG. 2 is an exploded view of the optical fiber connector of FIG. 1.

FIG. 3 is a sectional view taken along line of the optical fiber connector of FIG. 1.

FIG. 4 is an enlarged view of the lensed optical fiber of FIG. 2.

FIG. 5 is a schematic, isometric view of an optical fiber connector, according to a second exemplary embodiment.

FIG. 6 is a sectional view taken along line VI-VI of the optical fiber connector of FIG. 5.

### DETAILED DESCRIPTION

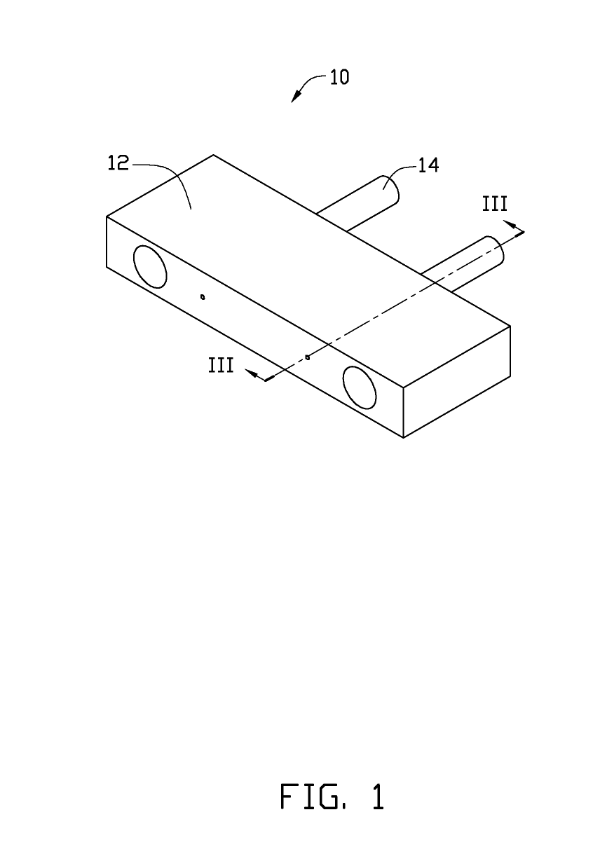

Referring to FIG. 1, an optical fiber connector 10, according to a first exemplary embodiment, includes a body 12 and two lensed optical fibers 14.

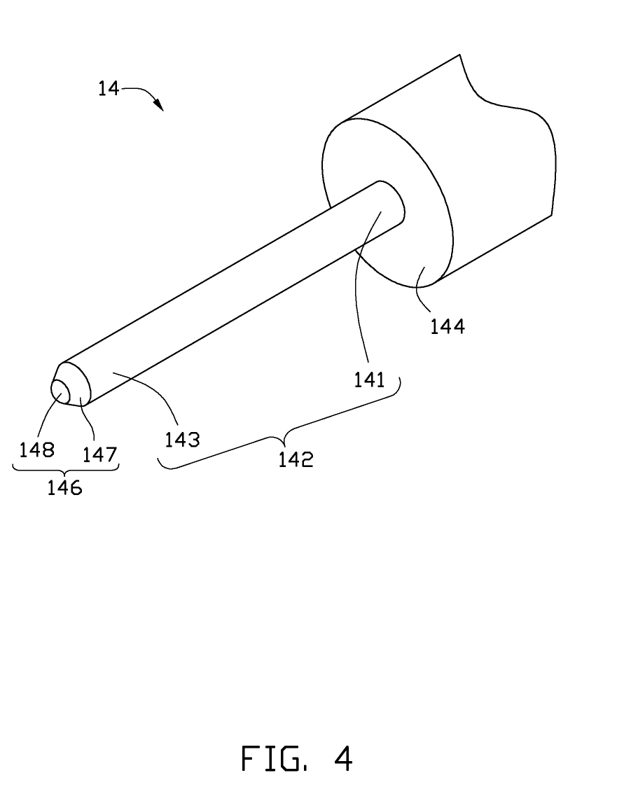

Referring to FIG. 4, each lensed optical fiber 14 includes a transparent core portion 142, a cladding layer 144, and an optical lens 146. The core portion 142 is configured for transmitting optical signals. The core portion 142 includes a first end 141 and a second end 143 opposite to the first end 141. The second end 143 is an exposed end. The cladding layer 144 is made of material with a lower index of refraction, compared with the index of refraction of the core portion 142. The cladding layer 144 wraps around the first end 141 of the core portion 142. The optical lens 146 includes a platform 147 and a spherical portion 148. The platform 147 is a frustum of a cone and extends from the second end 143 along the lengthwise direction of the core portion 142. The spherical portion 148 has a spherical surface and extends from the platform 147 along the lengthwise direction of the core portion 142. The platform 147 is positioned between the spherical portion 148 and a distal surface of the second end 143. In this embodiment, the core portion 142 and the optical lens 146 are made of quartz. The manufacture procedure of the lensed optical fiber 14 is chemical etching.

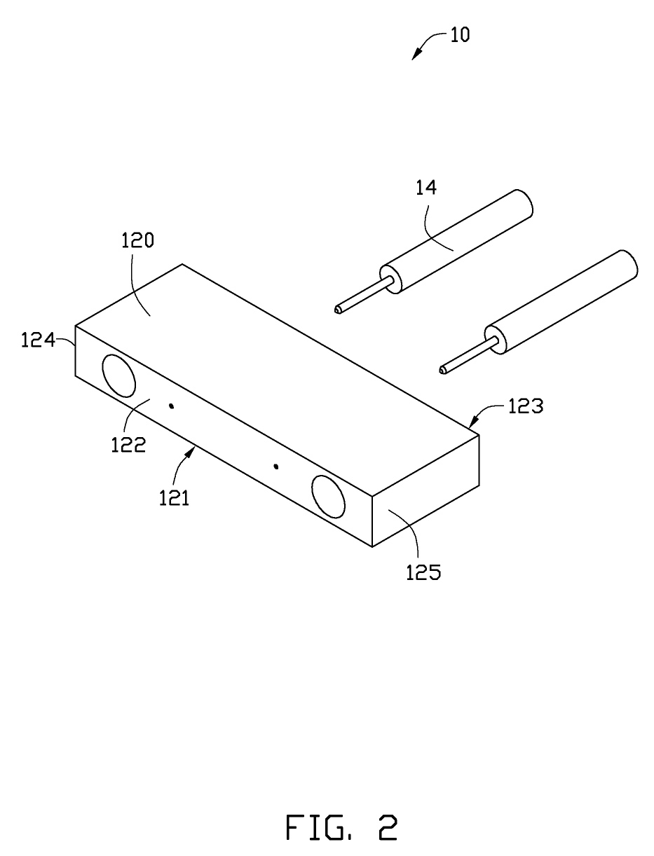

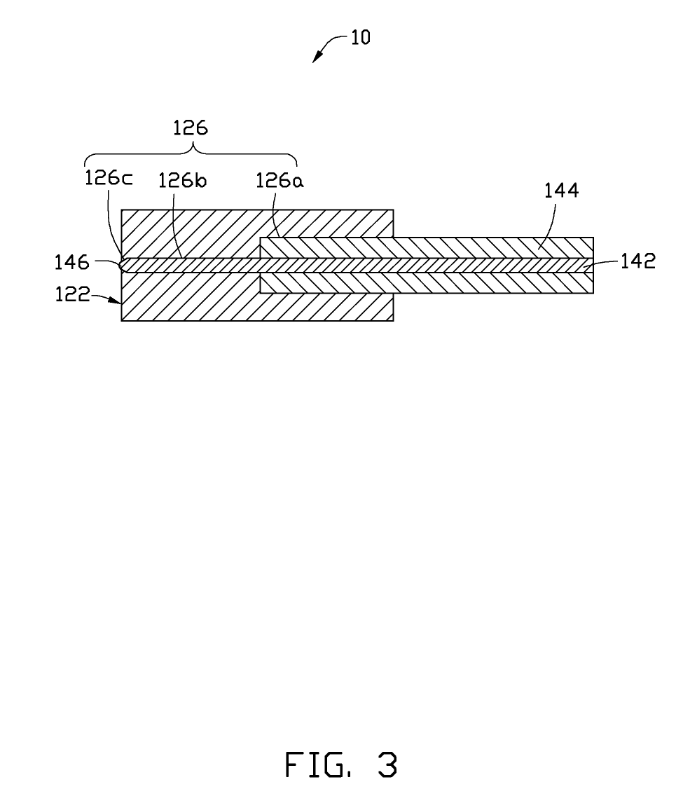

Referring to FIGS. 2-3, the body 12 includes an upper surface 120, a lower surface 121, a first sidewall 122, a second sidewall 123, a third sidewall 124, and a fourth sidewall 125. The upper surface 120 is substantially parallel to the lower surface 121. The first sidewall 122 is substantially parallel to the second sidewall 123. The third sidewall 124 is substantially parallel to the fourth sidewall 125. The first sidewall 122, the third sidewall 124, the second sidewall 123, and the fourth sidewall 125 are connected end-to-end to each other. The first sidewall 122, the third sidewall 124, the second sidewall 123, and the fourth sidewall 125 perpendicularly connect the upper surface 120 to the lower surface 121.

The body 12 defines two receiving through holes 126 from the second sidewall 123 to the first sidewall 122. Each receiving through hole 126 includes a first receiving hole portion 126a, a second receiving hole portion 126b, and a third receiving hole portion 126c connecting end to end in corresponding order, along a direction where the lensed optical fibers 14 are inserted into the receiving through holes 126. The diameters of the first receiving hole portion 126a, the second receiving hole portion 126b, and the third receiving hole portion 126c gradually decrease. The first receiving hole 126a engages with the cladding layer 144. The second receiving hole 126b engages with the core portion 142. The third receiving hole portion 126c engages with the platform 147, and the spherical portion 148 protrudes from the first sidewall 122.

In other embodiments, the spherical portion 148 may also be received in the third receiving hole portion 126c.

When in use, if the optical fiber connector 10 serves as an emitter, light emitted from the core portion 142 directly enters into the optical lens 146, and reaches on the optical lens of another lensed optical fiber (not shown), which serves as a receiver coupled with the optical fiber connector 10. If the optical fiber connector 10 severs as a receiver, light emitted from the another lensed optical fiber, which serves as an emitter coupled with the optical fiber connector 10, passes through the optical lens 146 and directly enters into the core portion 142. The light path becomes simple as the mount of the refracting interface is reduced. This increases transmission efficiency of optical fiber connector 10.

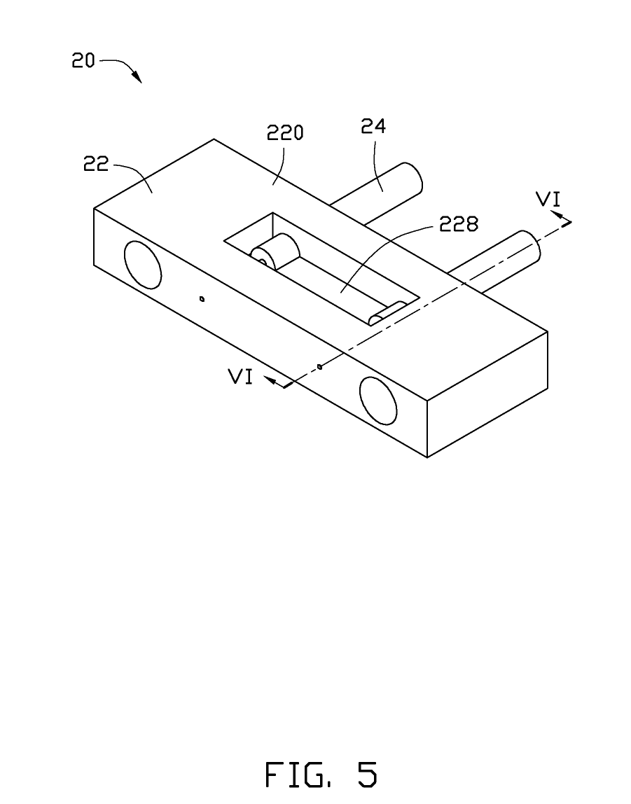

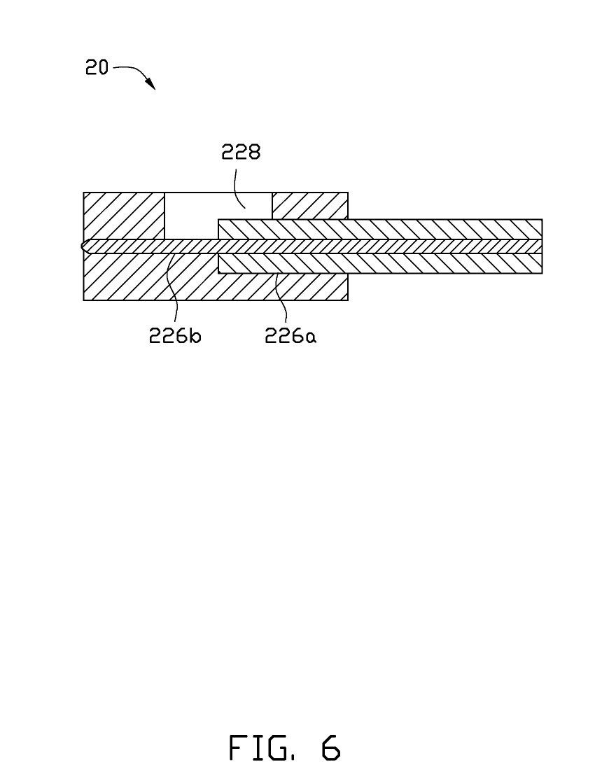

Referring to FIGS. 5-6, an optical fiber connector 20, according to a second exemplary embodiment, is shown. The difference between the optical fiber connector 20 of this embodiment and the optical fiber connector 10 of the first exemplary embodiment is, a groove 228 is defined in a central portion of an upper surface 220 of the body 22. The groove 228 is in communication with the first receiving hole portion 226a and the second receiving hole portion 226b. Lensed optical fibers 24 are inserted into the body 22 and are attached to the body 22 with glue through the groove 228.

Advantages of the optical fiber connector 20 of the second exemplary embodiment are similar to those of the optical fiber connector 10 of the first exemplary embodiment.

It is to be understood, however, that even though numerous characteristics and advantages of the present embodiments have been set fourth in the foregoing description, together with details of the structures and functions of the embodiments, the disclosure is illustrative only, and changes may be made in details, especially in matters of shape, size, and arrangement of parts within the principles of the disclosure to the full extent indicated by the broad general meaning of the terms in which the appended claims are expressed.

What is claimed is:

1. An optical fiber connector comprising:
a plurality of lensed optical fibers each comprising a core portion, a cladding layer, and an optical lens, the core portion comprising a first end and a second end opposite to the first end, the cladding layer wrapping around the first end, the optical lens formed on a distal surface of the second end; and
a body defining a plurality of receiving through holes therethrough, the lensed optical fibers inserted in the respective receiving through holes with the optical lenses disposed at openings of the receiving through holes.

2. The optical fiber connector as claimed in claim 1, wherein the optical lens comprises a platform and a spherical portion, the platform extends from the distal surface of the second end along the lengthwise direction of the core portion, the spherical portion extends from the platform along the lengthwise direction of the core portion, and the platform is positioned between the spherical portion and the distal surface of the second end.

3. The optical fiber connector as claimed in claim 2, wherein the platform is a frustum of a cone, and the spherical portion has a spherical surface.

4. The optical fiber connector as claimed in claim 3, wherein each receiving through holes comprises a first receiving hole portion receivingly engaging with the cladding layer, a second receiving hole portion receivingly engaging with the core portion, and a third receiving hole portion receiving the optical lens.

5. The optical fiber connector as claimed in claim 4, wherein the platform is receivingly engaged in the third receiving hole portion, and the spherical portion protrudes beyond the body.

6. The optical fiber connector as claimed in claim 4, wherein the platform is receivingly engaged in the third receiving hole portion, and the spherical portion is received in the third receiving hole portion.

7. The optical fiber connector as claimed in claim 4, wherein a groove is defined in an upper surface of the body, the groove is in communication with the receiving through holes.
